(19) United States
(12) Patent Application Publication
(10) Pub. No.: US 2013/0054713 A1
(43) Pub. Date: Feb. 28, 2013

(54) FILE UPLOAD SYSTEM USING COMMUNICATION TERMINAL AND METHOD THEREOF

(71) Applicants: Young Min JHON, Seoul (KR); Chi Woong Jang, Yongin-Si (KR); Deok Ha Woo, Seoul (KR); Sun Ho Kim, Seoul (KR); Seok Lee, Seoul (KR)

(72) Inventors: Young Min JHON, Seoul (KR); Chi Woong Jang, Yongin-Si (KR); Deok Ha Woo, Seoul (KR); Sun Ho Kim, Seoul (KR); Seok Lee, Seoul (KR)

(21) Appl. No.: 13/453,186

(22) Filed: Apr. 23, 2012

(30) Foreign Application Priority Data
Aug. 22, 2011 (KR) 10-2011-0083466

(51) Int. Cl. G06F 15/16

(52) U.S. Cl. 709/206

(57) ABSTRACT

A file upload system using a communication terminal includes a communication terminal, a mail server and a web server. The mail server receives an attached file together with an e-mail transmitted to at least one previously allocated reception-side mail account from the communication terminal and stores the received e-mail and attached file. The web server provides a webpage to which a file is to be uploaded to the communication terminal, and provides a web service through which the file is uploaded to the corresponding webpage.

### CROSS-REFERENCE TO RELATED APPLICATION

This application claims priority to and the benefit of Korean Patent Application No. 2011-0083466, filed on Aug. 22, 2011, the disclosure of which is incorporated herein by reference in its entirety.

### BACKGROUND

1. Field of the Invention

The present invention relates to a file upload system using a communication terminal and a method thereof, and more particularly, to a file upload system using a communication terminal and a method thereof, in which a file is uploaded to a web server using a file attached to an electronic mail (e-mail) or multimedia messaging service (MMS) message transmitted to a separate mail server or message server linked with the web server, instead of a conventional method of uploading a file (e.g., an image, photograph, moving picture, document file, etc.) to a web server running a webpage such as blog or Twitter through a communication terminal using a separate application, thereby effectively reducing a huge cost necessary for developing and producing a conventional application for file uploading.

2. Discussion of Related Art

In general, supplementary services provided through the Internet are rapidly increasing with the rapid development of communication networks and the rapid spread of PCs. A content provider providing supplementary services builds up a web server having an application program, a database, etc., used to provide the corresponding supplementary services, and provides the corresponding supplementary services to client terminals accessing the web server through the Internet.

Among these supplementary services, a blog service is one of supplementary services popularized by Internet users. The word ‘blog’ is an abbreviation of ‘web log,’ and is a kind of personal medium through which people can freely upload diaries, columns, articles, etc. according to their interests, and includes various forms such as personal publishing, personal broadcasting and community.

Current blog services have an advantage in that web boards and personal homepage functions are mixed together in the blog service, and a user having no knowledge related to the production of an Internet homepage can make his or her own space. That is, the blog service is a medium using a new concept through which anyone who has only a blog page can upload his or her own opinions, stories or image data using a text or graphic scheme.

The conventional blog service is a system in which an Internet user joins the blog service as a member by accessing the blog service connected to an Internet network and then simply produces his or her own blog account according to the procedure illustrated in the blog service. After producing the blog account, the blog service user can immediately access the blog service through the Internet anytime and anywhere and write scripts in various manners on his or her own account. The scripts written by the blog service user are set to public or private so as to be open to other members using the blog service or other Internet users to whom the blog service is accessible.

Recently, mobile blogs in which a user can access a blog service using a communication terminal, etc. have been spreading.

### SUMMARY OF THE INVENTION

The present invention is directed to a file upload system using a communication terminal and a method thereof, in which a file is uploaded to a web server using a file attached to an electronic mail (e-mail) or multimedia messaging service (MMS) message transmitted to a separate mail server or message server linked with the web server, instead of a conventional method of uploading a file (e.g., an image, photograph, moving picture, document file, etc.) to a web server running a webpage such as blog or Twitter through a communication terminal using a separate application, thereby effectively reducing a huge cost necessary for developing and producing a conventional application for file uploading.

According to an aspect of the present invention, there is provided a file upload system using a communication terminal, including: a communication terminal having a web browser built therein and performing electronic mail (e-mail) transmission; a mail server receiving an attached file together with an e-mail transmitted to at least one previously allocated reception-side mail account from the communication terminal, using a previously set transmission-side mail account, and storing the received e-mail and attached file; and a web server providing a webpage to which a file is to be uploaded to the communication terminal, allocating a reception-side mail account receivable in the mail server and transmitting the allocated reception-side mail account to the communication terminal, receiving the attached file of the e-mail previously stored in the mail server in connection with the mail server and providing a web service through which the received attached file is displayed through the web browser of the communication terminal, and providing a web service through which the file is uploaded to the corresponding webpage.

The mail server may establish, as a database for each transmission-side mail account, the attached file together with the e-mail received at the reception-side mail account previously allocated to the communication terminal through the web server, and store the e-mail and the attached file.

The web server may allocate a reception-side mail account for a member using a member login ID of a communication terminal, a user of which subscribes to the web server as a member, and transmit the allocated reception-side mail account to the corresponding communication terminal. The web server arbitrarily may allocate a virtual reception-side mail account to a user of a communication terminal, a user of which does not subscribe to the web server as a member, and transmit the allocated virtual reception-side mail account to the corresponding communication terminal.

When the web server receives a request message for selecting a file to be uploaded from the communication terminal, the user of which subscribes to the web server as a member, the web server searches for e-mails transmitted to a transmission-side mail account of the communication terminal, the user of which subscribes to the web server as a member, or received at the reception-side mail account for a member in connection to the mail server, provide a web service through which mail reception information containing the reception date and time of each of the searched e-mails is sequentially displayed in the corresponding communication terminal, and provide a web service through which an attached file corresponding to the displayed mail reception information is selectively displayed in the corresponding communication terminal.

When the web server receives a request message for selecting a file to be uploaded from the communication terminal, the user of which does not subscribe to the web server as a member, the web server may search for e-mails received at the virtual reception-side mail account through the corresponding communication terminal in connection to the mail server, provide a web service through which mail reception information containing the reception date and time of each of the searched e-mails is sequentially displayed in the corresponding communication terminal, and provide a web service through which an attached file corresponding to the displayed mail reception information is selectively displayed in the corresponding communication terminal.

The web server may delete, after a predetermined time, the e-mail stored in the mail server and the attached file corresponding to the e-mail together with the allocated virtual reception-side mail account.

According to another aspect of the present invention, there is provided a file upload system using a communication terminal, including: a communication terminal having a web browser built therein and performing multimedia messaging service (MMS) message transmission; a message server receiving an attached file together with an MMS message transmitted to at least one previously allocated reception-side phone number, using a transmission-side phone number of the communication terminal, and storing the received MMS message and attached file; and a web server providing a webpage to which a file is to be uploaded to the communication terminal, allocating a reception-side phone number receivable in the message server and transmitting the allocated reception-side phone number to the communication terminal, receiving the attached file of the MMS message previously stored in the message server in connection with the message server and providing a web service through which the received attached file is displayed through the web browser of the communication terminal, and providing a web service through which the file is uploaded to the corresponding webpage.

The message server may establish, as a database for each transmission-side phone number, the attached file together with the MMS message received at the reception-side phone number previously allocated to the communication terminal through the web server, and store the MMS message and the attached file.

When the web server receives a request message for selecting a file to be uploaded from the communication terminal, the web server may search for MMS messages received at the transmission-side phone number of the corresponding communication terminal among the MMS messages received at the reception-side phone number allocated to the communication terminal in connection to the message server, provide a web service through which message reception information containing the reception date and time of each of the searched MMS messages is sequentially displayed in the corresponding communication terminal, and provide a web service through which an attached file corresponding to the displayed message reception information is selectively displayed in the corresponding communication terminal.

According to a still another aspect of the present invention, there is provided a method of uploading a file to a webpage provided from a web server using a system which includes a communication terminal having a web browser built therein and performing e-mail transmission, a web server and a mail server, the method including: (a) accessing a webpage to which a file provided from the web server is to be uploaded through the web browser of the communication terminal; (b) allocating, by the web server, a reception-side mail account receivable in the mail server and transmitting the allocated reception-side mail account to the communication terminal, when receiving a request message of a mail account for file uploading from the communication terminal through the web server; (c) transmitting an attached file together with an e-mail to the mail server using a transmission-side mail account previously set through the communication terminal and the allocated reception-side mail account; (d) receiving e-mails and attached files transmitted to at least one previously allocated reception-side mail account using the transmission-side mail account previously set from the communication terminal through the mail server, and storing the received e-mails and attached files; (e) receiving, by the web server, mail reception information on e-mails previously stored in the mail server and attached files, and providing a web service through which the received mail reception information and attached files are displayed in the communication terminal, when receiving a request message for selecting a file to be uploaded from the communication terminal through the web server; and (f) selecting at least one of the attached files displayed in step (e) through the communication terminal, and uploading the selected attached file to the webpage provided from the web server.

In step (b), when the web server receives the request message of the mail account for file uploading from the communication terminal, the web server may determine the presence of a member login of the corresponding communication terminal, allocate a reception-side mail account for a member using a member login ID of a communication terminal, a user of which subscribes to the web server as a member and transmit the allocated reception-side mail account to the corresponding communication terminal. The web server may arbitrarily allocate a virtual reception-side mail account to a user of a communication terminal, a user of which does not subscribe to the web server as a member and transmit the allocated virtual reception-side mail account to the corresponding terminal.

The web server may delete, after a predetermined time, the e-mail stored in the mail server and the attached file corresponding to the e-mail together with the allocated virtual reception-side mail account.

In step (d), the mail server may establish, as a database for each transmission-side mail account, the attached file together with the e-mail received at the reception-side mail account previously allocated to the communication terminal through the web server, and store the e-mail and the attached file.

In step (e), when the web server receives a request message for selecting a file to be uploaded from the communication terminal, the user of which subscribes to the web server as a member, the web server searches for e-mails transmitted to a transmission-side mail account of the communication terminal, the user of which subscribes to the web server as a member, or received at the reception-side mail account for a member in connection to the mail server, provides a web service through which mail reception information containing the reception date and time of each of the searched e-mails is sequentially displayed in the corresponding communication terminal, and provides a web service through which an attached file corresponding to the displayed mail reception information is selectively displayed in the corresponding communication terminal.

In step (e), when the web server receives a request message for selecting a file to be uploaded from the communication terminal, the user of which does not subscribe to the web server as a member, the web server may search for e-mails received at the virtual reception-side mail account through the corresponding communication terminal in connection to the mail server, provide a web service through which mail reception information containing the reception date and time of each of the searched e-mails is sequentially displayed in the corresponding communication terminal, and provide a web service through which an attached file corresponding to the displayed mail reception information is selectively displayed in the corresponding communication terminal.

According to a still another aspect of the present invention, there is provided a method of uploading a file to a webpage provided from a web server using a system which includes a communication terminal having a web browser built therein and performing MMS message transmission, a web server and a message server, the method including: (a′) accessing a webpage to which a file provided from the web server is to be uploaded through the web browser of the communication terminal; (b′) allocating, by the web server, a reception-side phone number receivable in the message server and transmitting the allocated reception-side phone number to the communication terminal, when receiving a request message of a phone number for file uploading from the communication terminal through the web server; (c′) transmitting an attached file together with an MMS message to the message server using a transmission-side phone number previously set through the communication terminal and the allocated reception-side phone number; (d′) receiving MMS messages and attached files transmitted to at least one previously allocated reception-side phone number using the transmission-side phone number previously set from the communication terminal through the message server, and storing the received MMS messages and attached files; (e′) receiving, by the web server, message reception information on MMS messages previously stored in the message server and attached files, and providing a web service through which the received message reception information and attached files are displayed in the communication terminal, when receiving a request message for selecting a file to be uploaded from the communication terminal through the web server; and (f′) selecting at least one of the attached files displayed in step (e′) through the communication terminal, and uploading the selected attached file to the webpage provided from the web server.

In step (d′), the message server may establish, as a database for each transmission-side phone number, the attached file together with the MMS message received at the reception-side phone number previously allocated to the communication terminal through the web server, and store the MMS message and the attached file.

In step (e′), when the web server receives a request message for selecting a file to be uploaded from the communication terminal, the web server may search for MMS messages received at the transmission-side phone number of the corresponding communication terminal among the MMS messages received at the reception-side phone number allocated to the communication terminal in connection to the message server, provide a web service through which message reception information containing the reception date and time of each of the searched MMS messages is sequentially displayed in the corresponding communication terminal, and provide a web service through which an attached file corresponding to the displayed message reception information is selectively displayed in the corresponding communication terminal.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a block configuration diagram schematically illustrating a file upload system using a communication terminal according to an exemplary embodiment of the present invention;

FIG. 2 illustrates a screen configuration for comparing and illustrating a webpage of a blog capable of uploading a file, displayed in the communication terminal according to the exemplary embodiment of the present invention, and a webpage of a conventional blog;

FIG. 3 is a flowchart illustrating a first example of a file upload method using the communication terminal according to the exemplary embodiment of the present invention;

FIGS. 4A to 4D illustrate screen configurations of a webpage displayed in the communication terminal, for illustrating the first example of FIG. 3 in detail;

FIG. 5 is a flowchart illustrating a second example of the file upload method using the communication terminal according to the exemplary embodiment of the present invention;

FIGS. 6A to 6D illustrate screen configurations of a webpage displayed in the communication terminal, for illustrating the second example of FIG. 5 in detail;

FIG. 7 is a flowchart illustrating a third example of the file upload method using the communication terminal according to the exemplary embodiment of the present invention;

FIGS. 8A to 8D illustrate screen configurations of a webpage displayed in the communication terminal, for illustrating the third example of FIG. 7 in detail;

FIG. 9 is a flowchart illustrating a fourth example of the file upload method using the communication terminal according to the exemplary embodiment of the present invention; and

FIGS. 10A to 10D illustrate screen configurations of a webpage displayed in the communication terminal, for illustrating the fourth example of FIG. 9 in detail.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

In exemplary embodiments of the present invention, recently used smart phones are applied as communication terminals, and image files are applied as files to be uploaded, but the present invention is not limited thereto. For example, all communicable terminals as well as smart phones may be applied as the communication terminals, and all files (e.g., moving pictures, document files, etc.) as well as image files may be applied as the files to be uploaded.

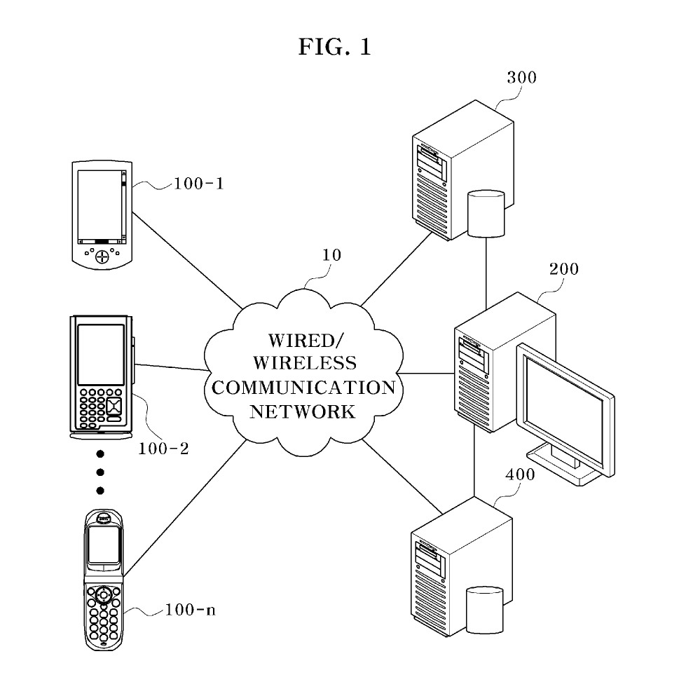

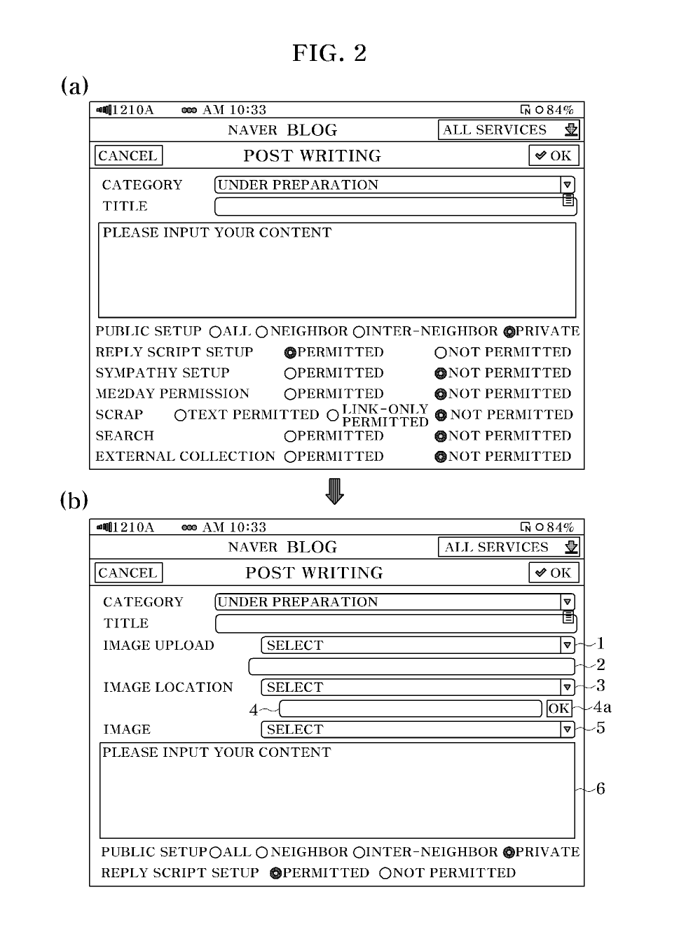

FIG. 1 is a block configuration diagram schematically illustrating a file upload system using a communication terminal according to an exemplary embodiment of the present invention. FIG. 2 illustrates a screen configuration for comparing and illustrating a webpage of a blog capable of uploading a file, displayed in the communication terminal according to the exemplary embodiment of the present invention, and a webpage of a conventional blog.

Referring to FIGS. 1 and 2, in the file upload system according to the exemplary embodiment of the present invention, at least one communication terminal 100-1 to 100-n is connected to a web server 200, a mail server 300 and/or a message server 400 through a wired/wireless communication network 10 so as to transmit/receive data with the servers.

Here, the wired/wireless communication network 10 may be, for example, a mobile communication network, the Internet, a local area network (LAN), a wireless LAN (WiFi) network, etc. so as to perform bidirectional or unidirectional data transmission/reception between the communication terminals 100-1 to 100-n and the web server 200, the mail server and/or the message server 400.

The mobile communication network is a known communication network that provides wireless data communication such as wireless Internet together with voice communication to the communication terminals 100-1 to 100-n through a base station.

The Internet refers to a worldwide open computer network structure that provides several services existing in TCP/IP protocol and its upper layer, i.e., hyper text transfer protocol (HTTP), Telnet, file transfer protocol (FTP), domain name system (DNS), simple mail transfer protocol (SMTP), simple network management protocol (SNMP), network file service (NFS), network information service (NIS), etc. The Internet provides an environment which enables users of each of the communication terminals 100-1 to 100n to access the web server 200, the mail server 300 and/or the message server 400. Meanwhile, the Internet may be wired or wireless Internet. In addition, the Internet may be a core network integrated with a wired public network, wireless mobile communication network, portable Internet, etc.

The wireless LAN (WiFi) network is a known wireless data communication network for providing wireless Internet services to the communication terminals 100-1 to 100-n in wireless LAN zones respectively formed by a plurality of wireless LAN access points (APs).

The communication terminals 100-1 to 100-n are terminals capable of performing wired/wireless communication. For example, the communication terminal 100-1 to 100-n may be implemented as a communication terminal such as a personal digital assistant (PDA), smart phone, handheld personal computer (PC), cellular phone, PC or notebook computer, which is provided with a predetermined communication module such as a code division multiplexing access (CDMA) module, Bluetooth module, infrared data association (IrDA) module or wired/wireless LAN card, so as to access various webpages provided from the web server 200 through the wired/wireless communication network 10 and to perform unidirectional or bidirectional data transmission/reception to/from the mail server 300 and/or the message server 400.

That is, the communication terminals 100-1 to 100-n may be all kinds of wired/wireless communication devices that can use bidirectional transmission/reception services by accessing the web server 200 through the wired/wireless communication network 10.

For example, the communication terminals 100-1 to 100-n may include mobile terminals such as a personal communication service (PCS) phone, a cellular phone and a synchronous/asynchronous international mobile telecommunication-2000 (IMT-2000). In addition, the communication terminals 100-1 to 100-n may include all wired/wireless household/communication devices each having a user interface for accessing the web server 200, such as a palm PC, a personal digital assistant (PAD), a smart phone, a wireless application protocol (WAP) phone, a mobile play-station, a PC and a notebook computer.

The communication terminals 100-1 to 100-n configured as described above, for example, may be connected to a web service module, etc. of the web server 200 through the wired/wireless communication network 10 such as a mobile communication network or wired/wireless Internet, or may receive various webpage providing services provided from the web service module of the web server 200 through a general web browser.

The communication terminal 100-1 to 100-n may be exemplified as, for example, a portable cellular phone, etc. which can perform a voice communication, a video communication, a short message service (SMS) and/or multimedia message service (MMS) message communication, and other data communications. Although the configuration of the communication terminal 100-1 to 100-n is not shown in these figures, the communication terminal 100-1 to 100-n generally includes a control unit, a mobile communication unit, a key input unit, a display unit, a memory unit, etc.

The key input unit includes input keys through which numbers and characters are input by a subscriber and function keys through which functions are selected by the subscriber. Meanwhile, the key input unit may further include a touch panel built together with the display unit so as to recognize a user's pressing operation.

The display unit may include, for example, a liquid crystal display (LCD) to display characters and numbers under control of the control unit or display a functional menu screen and display text, images, etc.

The mobile communication unit is configured to transmit/receive audio and/or data to/from the wired/wireless mobile communication network 10. For example, the mobile communication unit communicates with the wired/wireless mobile communication network 10 by forming a communication channel through code division multiple access (CDMA), frequency division multiple access (FDMA), time division multiple access (TDMA), wideband code division multiple access (WCDMA), wireless broadband Internet scheme, Wibro, FTH, etc.

The memory unit stores programs for controlling general operations of the communication terminals 100-1 to 100-n, and arbitrarily stores data generated while the programs are executed. According to the exemplary embodiment of the present invention, the memory unit stores files (e.g., images, photographs, moving pictures, document files, etc.) to be uploaded to the web server 200.

The web server 200 functions to provide, to a corresponding communication terminal 100-1 to 100n, various webpages such as a blog or Twitter, to which files (preferably, image files) can be uploaded, as the corresponding communication terminal 100-1 to 100n is connected to web server 200.

For example, (a) of FIG. 2 illustrates a webpage (e.g., a NAVER blog) of a general personal blog, displayed on a screen by accessing the web server 200 through a web browser (e.g., Safari) of the communication terminal 100-1 to 100-n. The webpage of the general personal blog has a post menu window (e.g., post writing) composed of menus for posting (e.g., a category selection bar, a title and content input window, various selection buttons for public setup/reply script setup/sympathy setup/Me2 day permission/scrap/search/external collection, etc.).

That is, in a webpage of the conventional personal blog, it is possible to perform only the uploading of script writing, but it is impossible to perform the uploading of files, e.g., images such as photographs, moving pictures, documents, etc. Therefore, a separate posting-only application (or “app”) should be downloaded, installed and executed in order to upload a file (e.g., an image) to the webpage of the conventional personal blog.

However, as shown in (b) of FIG. 2, the web server 200 to which the exemplary embodiment of the present invention is applied provides a webpage to which a file (e.g., an image) can be uploaded without using the conventional posting-only application.

That is, the webpage provided from the web server 200 includes a key select menu bar 1 for receiving a specific key value (e.g., a reception-side mail account, phone number, etc.) so as to upload an additional file to the conventional post menu window shown in (a) of FIG. 2, a key display window 2 for displaying the key value selected in the key select menu bar 1, a file location select menu bar 3 for selecting the location of a file to be uploaded, an input window 4 for inputting a transmission-side mail account or phone number transmitted by a user to upload a file, a file select menu bar 5 for selecting displayed files by sorting uploaded files for each date, an input/display window 6 for inputting scripts and displaying the files selected in the file select menu bar 5, etc.

The web server 200 allocates at least one reception-side mail account receivable from the mail server 300 according to a request of a user utilizing one of the communication terminals 100-1 to 100-n, and transmits the allocated mail account to the corresponding communication terminal 100-1 to 100-n. The web server 200 receives an attached file of an e-mail previously stored in the mail server 300 and provides a web service through which the attached file is displayed on a screen through a web browser of the corresponding communication terminal 100-1 to 100-n. In addition, the web server 200 provides a web service through which a file is uploaded to a specific webpage.

The web server 200 allocates a reception-side mail account for a member using a user login ID of a communication terminal 100-1 to 100-n, a user of which is subscribed to the web server 200 as a member, and transmits the allocated mail account to the corresponding communication terminal 100-1 to 100-n. The web server 200 arbitrarily allocates a virtual reception-side mail account for a user of a communication terminal 100-1 to 100-n, a user of which does not subscribe to the web server 200 as a member, and transmits the allocated mail account to the corresponding communication terminal 100-1 to 100-n.

When receiving a file select request message for uploading a file from the communication terminal 100-1 to 100-n, a user of which is joined to the web server 200 as a member, the web server 200 transmits the file select request message to a reception-side mail account of the corresponding communication terminal 100-n to 100-n in connection with the mail server 300 or searches for e-mails received at a reception-side mail account for a member. The web server 200 provides a web service through which mail reception information containing the reception date (year/month/day) and time (hour/minute) of the searched e-mails is sequentially displayed on a screen of the corresponding communication terminal 100-1 to 100-n. In addition, the web server 200 provides a web service through which an attached file corresponding to the displayed mail reception information is selectively displayed on the screen of the corresponding communication terminal 100-1 to 100-n.

When receiving an image select request message for file uploading from a communication terminal 100-1 to 100-n, a user of which does not subscribe to the web server 200 as a member, the web server 200 searches for e-mails received at a virtual reception-side mail account through a transmission-side mail account of the corresponding communication terminal 100-1 to 100-n in connection with the mail server 300. The web server 200 provides a web service through which mail reception information containing the reception date (year/month/day) and time (hour/minute) of the searched e-mails is sequentially displayed on a screen of the corresponding communication terminal 100-1 to 100-n. In addition, the web server 200 provides a web service so that an attached file corresponding to the displayed mail reception information is selectively displayed on the screen of the corresponding communication terminal 100-1 to 100-n. The web server 200 provides a web service through which an e-mail stored in the mail server 300 and an attached file corresponding to the e-mail is deleted together with the previously allocated reception-side mail account after a predetermined time (preferably, 24 hours or so).

Although the web server 200 allocates the same virtual reception-side mail account to the communication terminals 100-1 to 100-n, the users of which do not subscribe to the web server 200 as a member, the present invention is not limited thereto. For example, the web server 200 may allocate different virtual reception-side mail accounts to the respective communication terminals 100-1 to 100-n.

When the web server 200 allocates the same virtual reception-side mail account to the communication terminals 100-1 to 100-n, the web server 200 or the mail server 300 may provide a web service through which the previously allocated virtual reception-side mail account is not deleted, but only an e-mail received at the previously stored virtual reception-side mail account and an attached file corresponding to the email are deleted.

The web server 200 allocates at least one reception-side phone number receivable from the message server 400 according to a request of a user utilizing one of the communication terminals 100-1 to 100-n, and transmits the allocated phone number to the corresponding communication terminal 100-1 to 100-n. The web server 200 receives an MMS message and a file attached to the MMS message previously stored in the message server 400 in connection with the message server 400 and provides a web service through which the attached file is displayed on a screen through a web browser of the corresponding communication terminal 100-1 to 100-n. In addition, the web server 200 provides a web service through which a file is uploaded to a specific webpage.

When receiving a file select request message for uploading a file from the communication terminal 100-1 to 100-n, the web server 200 searches for MMS messages received at a transmission-side phone number of the corresponding communication terminal 100-1 to 100-n among the MMS messages received at the reception-side phone numbers allocated to the communication terminals 100-1 to 100-n in connection with the message server 400. The web server 200 provides a web service through which message reception information containing the reception date (year/month/day) and time (hour/minute) of the searched MMS messages is sequentially displayed on a screen of the corresponding communication terminal 100-1 to 100-n. In addition, the web server 200 provides a web service so that an attached file corresponding to the displayed mail reception information is selectively displayed on the screen of the corresponding communication terminal 100-1 to 100-n.

Although the web server 200 configured as described above preferably transmits information on the reception-side previously stored according to a user request of one of the communication terminals 100-1 to 100-n to the corresponding communication terminal 100-1 to 100-n in the state in which information on at least one reception-side mail account or phone number previously provided from the mail server 300 or the message sever 400 is stored, the present invention is not limited thereto. For example, the web server 200 may be configured to produce a reception-side mail account or phone number and to transmit the produced reception-side mail account or phone number to the mail server 300 or the message service 400 including the communication terminals 100-1 to 100-n so that data transmission/reception is possible.

The mail server 300 receives an e-mail and a file attached to the e-mail transmitted using a transmission-side mail account previously set from the communication terminal 100-1 and 100-n and at least one reception-side mail account previously allocated by the web server 200 through the wired/wireless communication network 10, and stores and manages the received e-mail and attached file.

In this case, the mail server 300 preferably establishes, as a database (DB) for each mail account, the e-mails and attached files received at the at least one reception-side mail account previously allocated to the communication terminals 100-1 to 100-n through the web server 200, and stores the e-mails and the attached files.

Although the mail server 300 may be separately provided to be linked with the web server 200 in the establishment of a specific website (or homepage), the present invention is not limited thereto. For example, the mail server 300 may use a free business mail, etc., served in a website such as Google, and may be integrated with the web server 200 so as to be established as one server.

The mail server 300 configured as described above acts as a reception-side mail server in a general mail system implemented so that an e-mail can be bidirectionally transmitted/received. Detailed descriptions of other components and their operations will be omitted.

The message server 400 receives MMS messages and files attached to the MMS messages transmitted to at least one reception-side telephone number previously allocated through the web server 200 using the transmission-side phone numbers of the communication terminal 100-1 to 100-n, and stores and manages the MMS messages and the attached files.

In this case, the message server 400 preferably establishes, as a database (DB) for each phone number, the MMS messages and attached files received at the at least one reception-side mail account previously allocated to the communication terminals 100-1 to 100-n through the web server 200, and stores the MMS messages and the attached files.

Meanwhile, the message server 400 acts as a reception-side message server in a general message transmission system implemented so that an SMS or MMS message can be bidirectionally transmitted/received. Detailed descriptions of other components and their operations will be omitted.

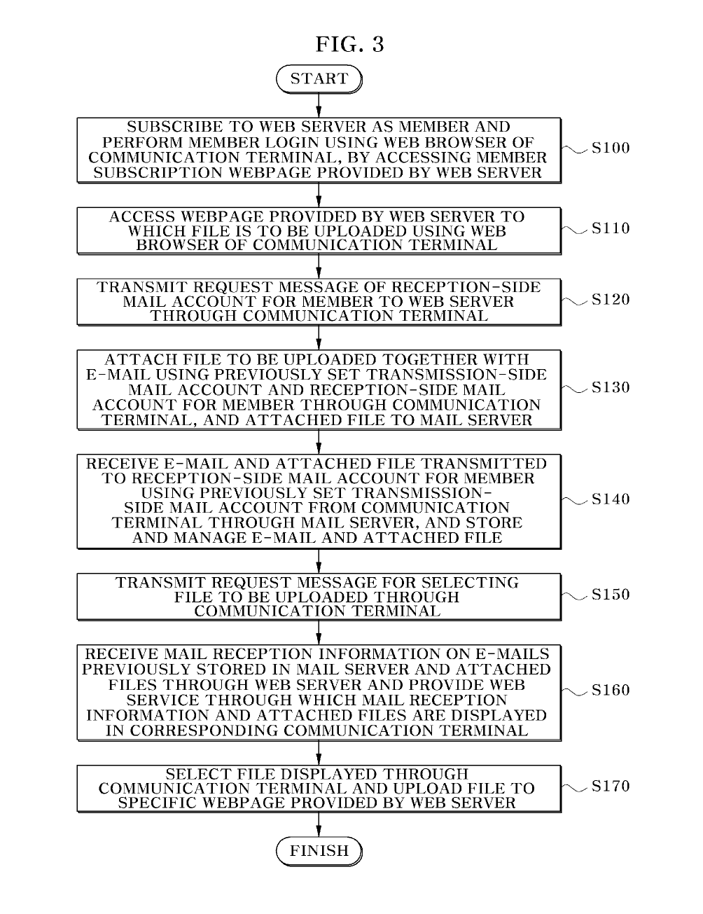

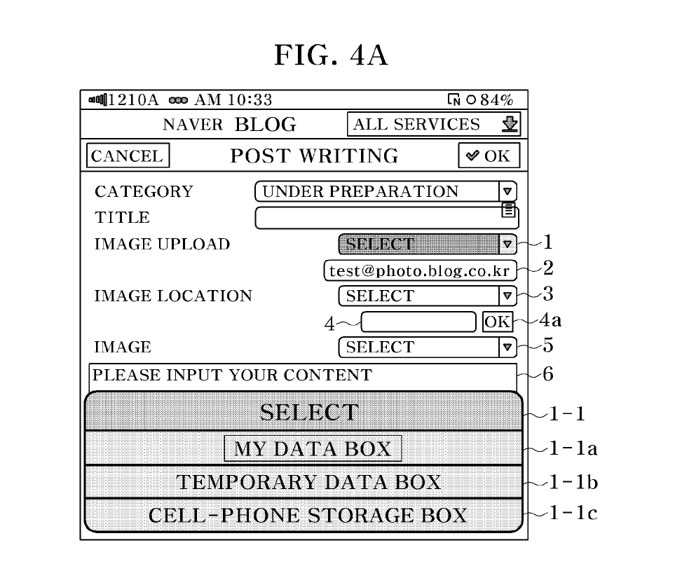

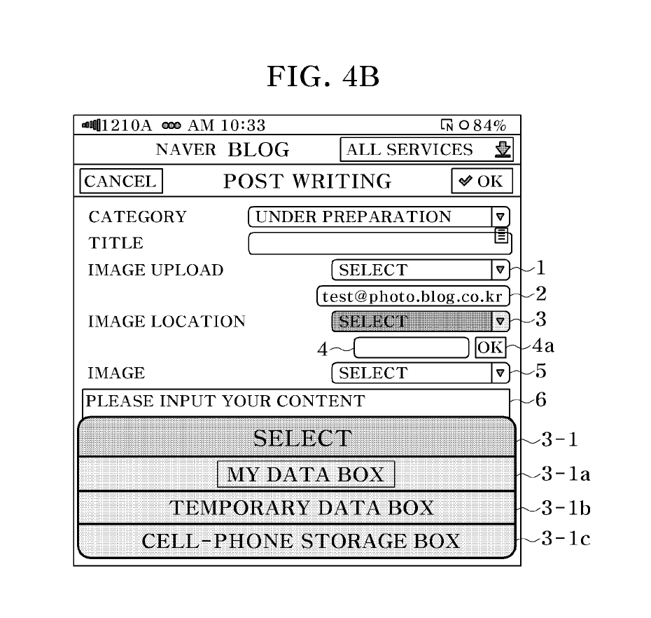

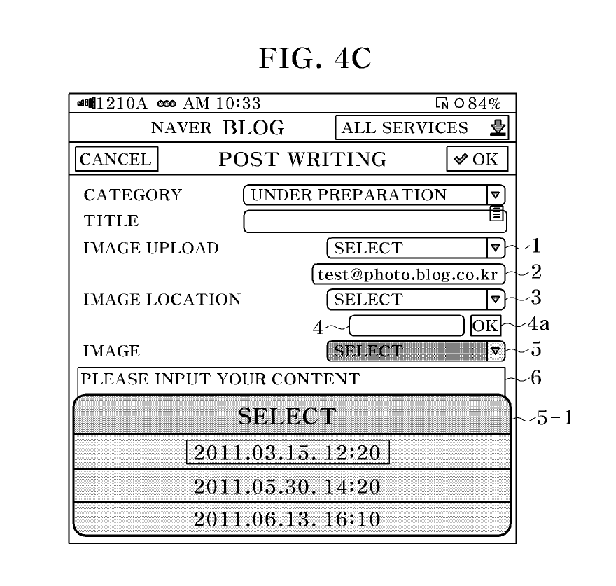

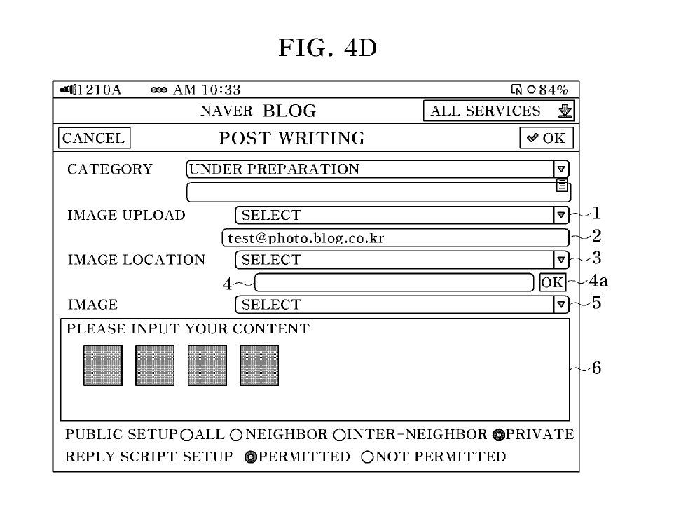

FIG. 3 is a flowchart illustrating a first example of a file upload method using the communication terminal according to the exemplary embodiment of the present invention. FIGS. 4A to 4D illustrate screen configurations of a webpage displayed in the communication terminal, for illustrating the first example of FIG. 3 in detail. FIGS. 3 and 4A to 4D illustrate a method of uploading a file (e.g., an image) to a specific webpage of the web server 200 through a communication terminal 100-1 to 100n, a user of which subscribes to the web server 200 as a member in the state in which the web server 200 and the mail server 300 are established.

Referring to FIGS. 1 to 3 and 4A to 4D, a user subscribes to the web server 200 as a member by accessing a member subscription webpage provided from the web server 200 using a web browser of a communication terminal 100-1 to 100-n and then performs a member login using a user ID and password provided when the user subscribes to the web server 200 (S100).

When the user subscribes to the web server 200 through the communication terminal 100-1 to 100-n, the web server 200 preferably provides a web service so as to receive information necessary for uploading a file (e.g., an image), e.g., a transmission-side mail account (e.g., abc@tni.com), transmission-side phone number (e.g., 010-XXXX-XXXX), etc.

If the user subscribes to the web server 200 through the communication terminal 100-1 to 100-n, the web server 200 or the mail server 300 automatically produces a reception-side mail account for a member (e.g., test@photo.blog.co.kr) using the user ID (i.e., test) provided when the user subscribes to the web server 200.

Meanwhile, the procedure in which the user subscribes to the web server 200 may be performed not using the communication terminal 100-1 to 100-n but using a separate external terminal (e.g., a desktop PC or laptop PC).

Next, if the user accesses a specific webpage provided from the web server 200 through the web browser of the communication terminal 100-1 to 100-n, for example, a webpage such as personal blog or Twitter, to which a file can be uploaded (S110), a menu window (e.g., post writing) for posting on a screen of the communication terminal 100-1 to 100-n is displayed, as shown in (b) of FIG. 2 and FIGS. 4A to 4D.

If the user intends to upload any one of files previously stored in the communication terminal 100-1 to 100-n to a specific webpage provided from the web server 200, the user first clicks the key select menu bar 1 provided in the post menu window through the communication terminal 100-1 to 100-n. Then, the corresponding communication terminal 100-1 to 100-n transmits a request message for selecting a specific key value (e.g., a reception-side mail account or phone number) for uploading the file to the web server 200.

Thereafter, when the user receives the request message for selecting the specific key value for uploading the file to the web server 200 from the communication terminal 100-1 to 100-n through the web server, as shown in FIG. 4A, the web server 200 provides a web service to the corresponding communication terminal 100-1 to 100-n so that a key select menu window 1-1 for selecting the specific key value is displayed in the form of a popup window.

In this case, the key select menu window 1-1 displayed in the communication terminal 100-1 to 100-n includes a first key select menu button 1-1a for receiving a reception-side mail account for a member, allocated by the web server 200 (e.g., my data box), a second key select menu button 1-1b for receiving a virtual reception-side mail account for a non-member, allocated by the web server 200 (e.g., temporary data box), and a third key select menu button 1-1c for receiving a reception-side phone number for a member/non-member, allocated by the web server 200 (e.g., cell-pone storage box).

If the user clicks the first select menu button 1-1a provided in the key select menu window 1-1 through the communication terminal 100-1 to 100-n, the corresponding communication terminal 100-1 to 100-n transmits a specific key value for uploading the file to the web server 200, i.e., a request message of the reception-side mail account for a member (S120).

Thereafter, when the web server 200 receives the request message of the reception-side mail account for a member from the corresponding communication terminal 100-1 to 100-n, the web server 200 determines the presence of a member login. If it is determined that the user is a user subscribing the web server 200 as a member, the web server 200 transmits the reception-side mail account produced when the user subscribes to the web server 200 to the corresponding communication terminal 100-1 to 100-n. If it is determined that the user is not subscribing the web server 200 as a member, the web server 200 provides a web service through which a request message for membership such as “membership is needed” is transmitted to the corresponding communication terminal 100-1 to 100-n and is displayed in the key display window 2.

Next, the user operates an e-mail application basically built in the communication terminal 100-1 to 100-n, attaches a file to be uploaded together with an e-mail using a previously set transmission-side mail account and the reception-side mail account displayed in the key display window 2, and transmits the e-mail and the attached file to the mail server 300 (S130).

Thereafter, the mail server 300 receives the e-mail and attached file transmitted to the reception-side mail account for a member from the communication terminal 100-1 to 100-n using the previously set transmission-side mail account and stores and manages the e-mail and the attached file as a database (DB) (S140).

Then, if the user clicks a file location selection menu bar 3 provided in the post menu window through the communication terminal 100-1 to 100-n, the corresponding communication terminal 100-1 to 100-n transmits a request message for selecting the location of the file to be uploaded to the web server 200.

Thereafter, when the web server 200 receives the request message for selecting the location of the file to be uploaded from the communication terminal 100-1 to 100-n, the web server 200 provides a web service to the corresponding communication terminal 100-1 to 100-n so that a file location select menu window 3-1 for selecting the file to be uploaded is displayed in the form of a popup window.

In this case, the file location select menu window 3-1 displayed in the communication terminal 100-1 to 100-n includes, as shown in FIG. 4B, a first file location select menu button 3-1a for selecting an attached file received at the reception-side mail account for a member (e.g., my data box), a second file location select menu button 3-1b for selecting an attached file received at the virtual reception-side mail account for a non-member (e.g., temporary data box), and a third file location select menu button 3-1c for selecting an attached file received at the reception-side phone number for a member/non-member (e.g., cell-phone storage box).

If the user clicks the first file location select menu button 3-1a provided in the file location select menu window 3-1 in the state in which the user logs into the web server 200 as a member, the corresponding communication terminal 100-1 to 100-n transmits a request message for selecting a file to be uploaded to the web server 200 (S150).

Next, when the web server 200 receives the request message for selecting the file to be uploaded from the communication terminal 100-1 to 100-n, the web server 200 receives mail reception information on e-mails previously stored in the mail server 300 and attached files and provides a web service through which the mail reception information and the attached files are displayed in the corresponding communication terminal 100-1 to 100-n (S160).

That is, when the web server 200 receives the request message for selecting the file to be uploaded from the communication terminal 100-1 to 100-n, the user of which subscribes to the web server 200 as a member, the web server 200 searches for e-mails transmitted to a transmission-side mail account of the communication terminal 100-1 to 100-n, the user of which subscribes to the web server as a member, or received at the reception-side mail account for a member in connection to the mail server 300.

Then, if the user clicks a file select menu bar 5 provided in the post menu window through the communication terminal 100-1 to 100-n, the corresponding communication terminal 100-1 to 100-n transmits, to the web server 200, a request message for displaying information on a file to be selected.

Thereafter, when the web server 200 receives the request message for displaying the information on the file to be selected from the communication terminal 100-1 to 100-n, as shown in FIG. 4C, the web server 200 sorts, for each date, mail reception information containing the reception date (year/month/day) and time (hour/minute) of each of the searched e-mails, and provides a web service through which a file selection menu window 5-1 for selecting an attached file corresponding to the mail reception information is displayed in the form of a popup window in the corresponding communication terminal 100-1 to 100-n.

Next, if the user clicks any of the mail reception information displayed in the file select menu window 5-1 through the communication terminal 100-1 to 100-n, as shown in FIG. 4D, the web server 200 provides a web service through which the attached file corresponding to the selected mail reception information is displayed in an input/display window 6 provided in the post menu window.

Thereafter, the user inputs characters in the input/display window 6 through the communication terminal 100-1 to 100-n and uploads the input characters together with the file displayed in the input/display window 6 to the specific webpage provided to the web server 200 (S170).

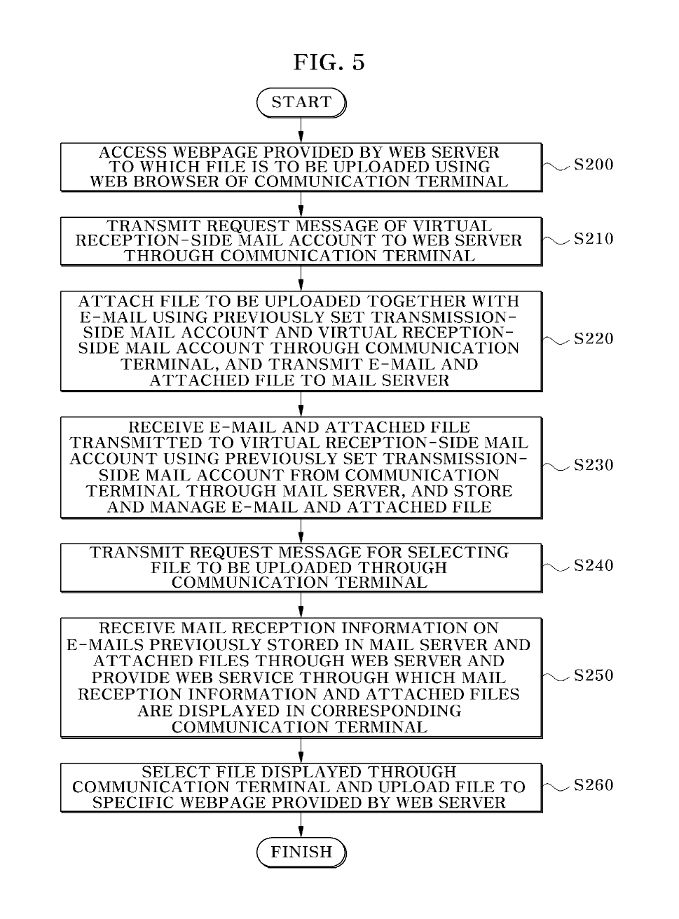

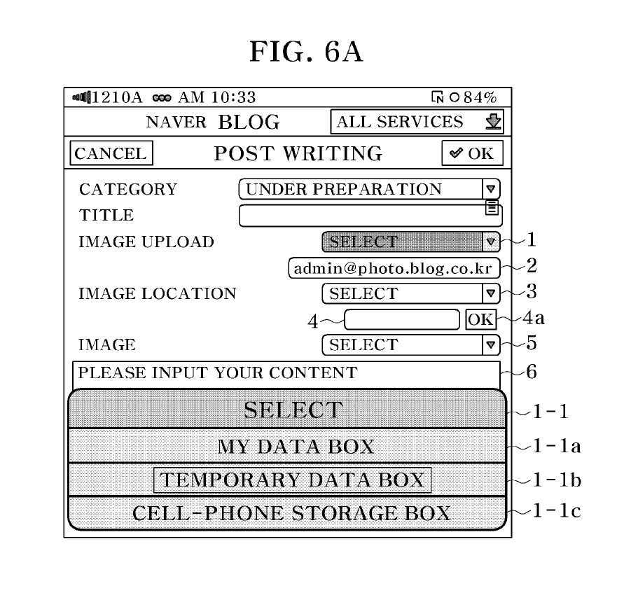

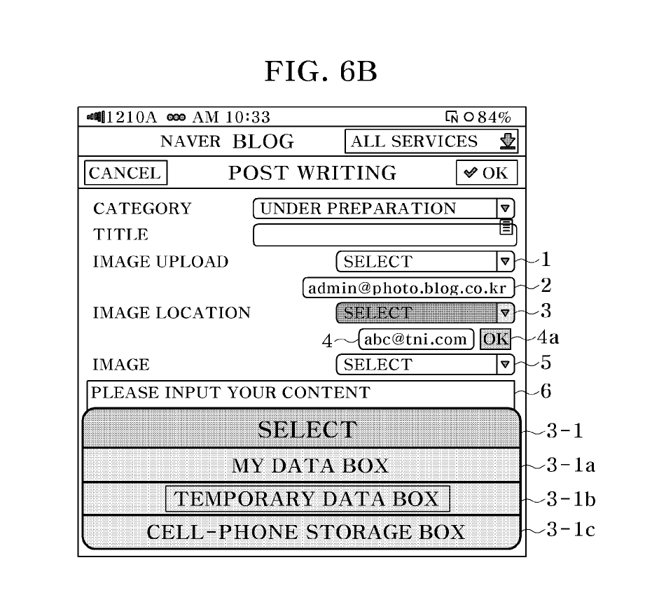

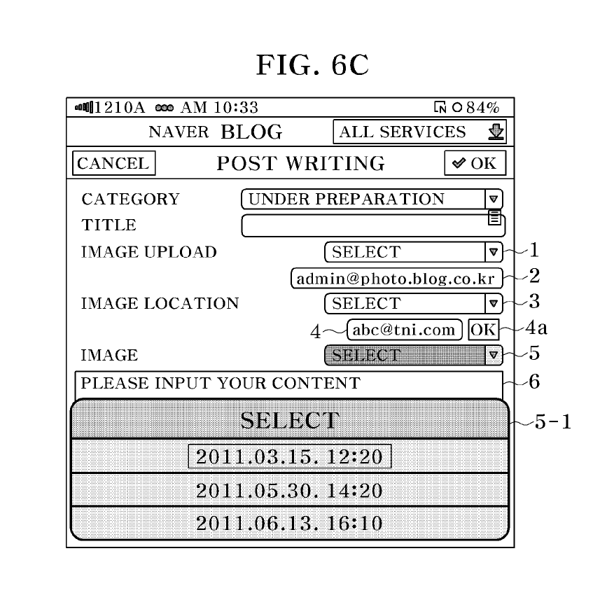

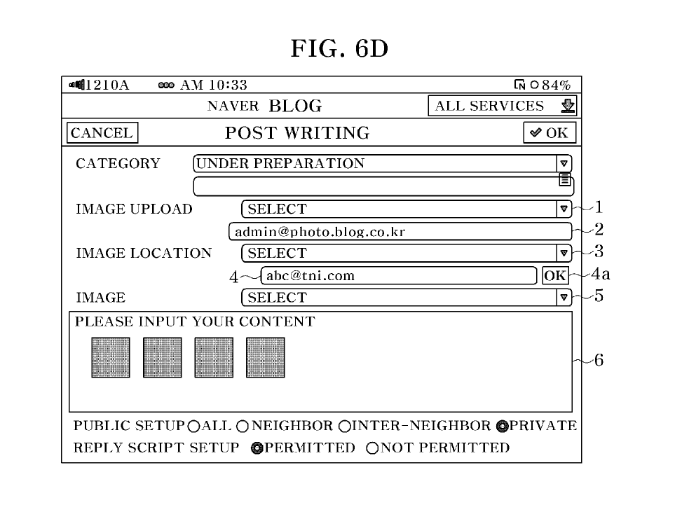

FIG. 5 is a flowchart illustrating a second example of the file upload method using the communication terminal according to the exemplary embodiment of the present invention. FIGS. 6A to 6D illustrate screen configurations of a webpage displayed in the communication terminal, for illustrating the second example of FIG. 5 in detail. FIGS. 5 and 6A to 6D illustrate a method of uploading a file (e.g., an image) to a specific webpage of the web server 200 through a communication terminal 100-1 to 100n, a user of which does not subscribe to the web server 200 as a member in the state in which the web server 200 and the mail server 300 are established.

Referring to FIGS. 1, 2, 5 and 6A to 6D, if a user accesses a specific webpage provided from the web server 200, e.g., a webpage such as personal blog or Twitter, to which a file can be uploaded, through a web browser of a communication terminal 100-1 to 100-n (S200), a post menu window for posting (e.g., post writing) is displayed on a screen of the communication terminal 100-1 to 100-n, as shown in (b) of FIG. 2 and FIGS. 6A to 6D.

When the user intends to upload any one of files previously stored in the communication terminal 100-1 to 100-n to a specific webpage provided from the web server 200, the user first clicks the key select menu bar 1 provided in the post menu window through the communication terminal 100-1 to 100-n. Then, the corresponding communication terminal 100-1 to 100-n transmits a request message for selecting a specific key value (e.g., a reception-side mail account, phone number, etc.) for uploading the file to the web server 200.

Thereafter, when the web server 200 receives the request message for selecting the specific key value for uploading the file from the communication terminal 100-1 to 100-n, as shown in FIG. 6A, the web server 200 provides a web service to the communication terminal 100-1 to 100-n so that a key select menu window 1-1 for selecting the specific key value is displayed in the form of a popup window.

In this case, the key select menu window 1-1 displayed in the communication terminal 100-1 to 100-n includes a first key select menu button 1-1a for receiving a reception-side mail account for a member, allocated by the web server 200 (e.g., my data box), a second key select menu button 1-1b for receiving a virtual reception-side mail account for a non-member, allocated by the web server 200 (e.g., temporary data box), and a third key select menu button 1-1c for receiving a reception-side phone number for a member/non-member, allocated by the web server 200 (e.g., cell-pone storage box).

If the user clicks the second select menu button 1-1b provided in the key select menu window 1-1 through the communication terminal 100-1 to 100-n, the corresponding communication terminal 100-1 to 100-n transmits a specific key value for uploading the file to the web server 200, i.e., a request message of the virtual reception-side mail account (S210).

Thereafter, when the web server 200 receives the request message of the virtual reception-side mail account from the corresponding communication terminal 100-1 to 100-n, the web server 200 allocates a virtual reception-side mail account (e.g., admin@photo.blog.co.kr), transmits the allocated virtual reception-side mail account to the corresponding communication terminal 100-1 to 100-n, and provides a web service to the corresponding communication terminal 100-1 to 100-n so that the virtual reception side mail account is displayed in a key display window 2.

Next, the user operates an e-mail application basically built in the communication terminal 100-1 to 100-n, attaches a file to be uploaded together with an e-mail using a previously set transmission-side mail account and the virtual reception-side mail account displayed in the key display window 2, and transmits the e-mail and the attached file to the mail server 300 (S220).

Thereafter, the mail server 300 receives the e-mail and attached file transmitted to the reception-side mail account for a member from the communication terminal 100-1 to 100-n using the previously set transmission-side mail account and stores and manages the e-mail and the attached file as a database (DB) (S230).

Then, if the user clicks a file location selection menu bar 3 provided in the post menu window through the communication terminal 100-1 to 100-n, the corresponding communication terminal 100-1 to 100-n transmits a request message for selecting the location of the file to be uploaded to the web server 200.

Thereafter, when the web server 200 receives the request message for selecting the location of the file to be uploaded from the communication terminal 100-1 to 100-n, the web server 200 provides a web service to the corresponding communication terminal 100-1 to 100-n so that a file location select menu window 3-1 for selecting the file to be uploaded is displayed in the form of a popup window.

In this case, the file location select menu window 3-1 displayed in the communication terminal 100-1 to 100-n includes, as shown in FIG. 6B, a first file location select menu button 3-1a for selecting an attached file received at the reception-side mail account for a member (e.g., my data box), a second file location select menu button 3-1b for selecting an attached file received at the virtual reception-side mail account for a non-member (e.g., temporary data box), and a third file location select menu button 3-1c for selecting an attached file received at the reception-side phone number for a member/non-member (e.g., cell-phone storage box).

If the user clicks the second file location select menu button 3-1b provided in the file location select menu window 3-1, inputs a previously set transmission-side mail account (e.g., abc@tni.com) in an input window 4 provided in the post menu window and then clicks an OK button 4a, in the state in which the user is not logged into the web server 200 as a non-member, the corresponding communication terminal 100-1 to 100-n transmits a request message for selecting a file to be uploaded to the web server 200 (S240).

Next, when the web server 200 receives the request message for selecting the file to be uploaded from the communication terminal 100-1 to 100-n, the web server 200 receives mail reception information on e-mails previously stored in the mail server 300 and attached files and provides a web service through which the mail reception information and the attached files are displayed in the corresponding communication terminal 100-1 to 100-n (S250).

That is, when the web server 200 receives the request message for selecting the file to be uploaded from a communication terminal 100-1 to 100-n, a user of which does not subscribe to the web server 200 as a member, the web server 200 searches for e-mails received at the virtual reception-side mail account through a transmission-side mail account of the corresponding communication terminal 100-1 to 100-n in connection with the mail server 300.

Then, if the user clicks a file select menu bar 5 provided in the post menu window through the communication terminal 100-1 to 100-n, the corresponding communication terminal 100-1 to 100-n transmits, to the web server 200, a request message for displaying information on a file to be selected.

Thereafter, when the web server 200 receives the request message for displaying the information on the file to be selected from the communication terminal 100-1 to 100-n, as shown in FIG. 6C, the web server 200 sorts, for each date, mail reception information containing the reception date (year/month/day) and time (hour/minute) of each of the searched e-mails, and provides a web service through which a file selection menu window 5-1 for selecting an attached file corresponding to the mail reception information is displayed in the form of a popup window in the corresponding communication terminal 100-1 to 100-n.

Next, if the user clicks any one of the mail reception information displayed in the file select menu window 5-1 through the communication terminal 100-1 to 100-n, as shown in FIG. 6D, the web server 200 provides a web service through which the attached file corresponding to the selected mail reception information is displayed in an input/display window 6 provided in the post menu window.

Thereafter, the user inputs characters in the input/display window 6 through the communication terminal 100-1 to 100-n and uploads the input characters together with the file displayed in the input/display window 6 to the specific webpage provided to the web server 200 (S260).

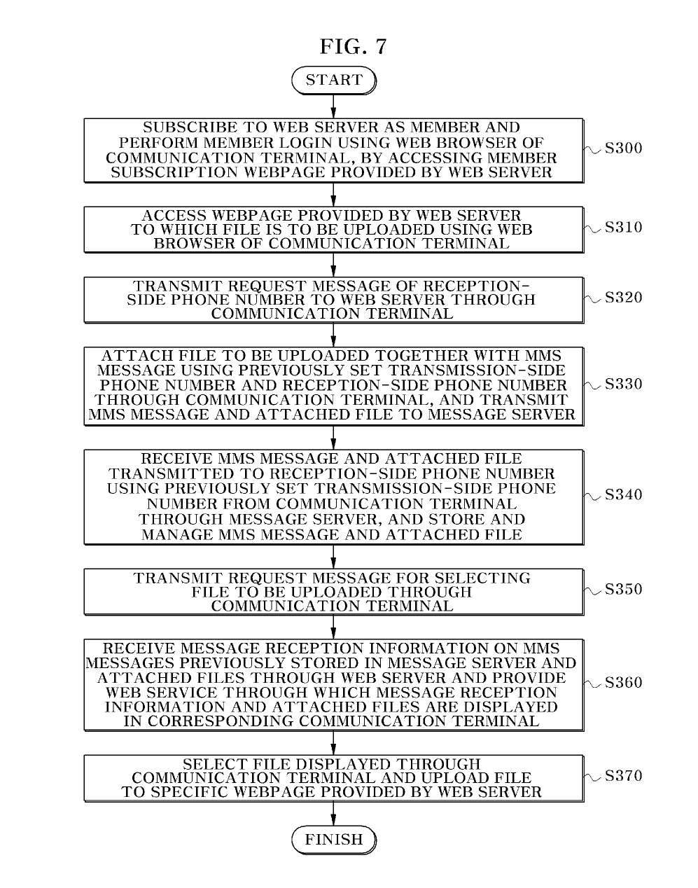

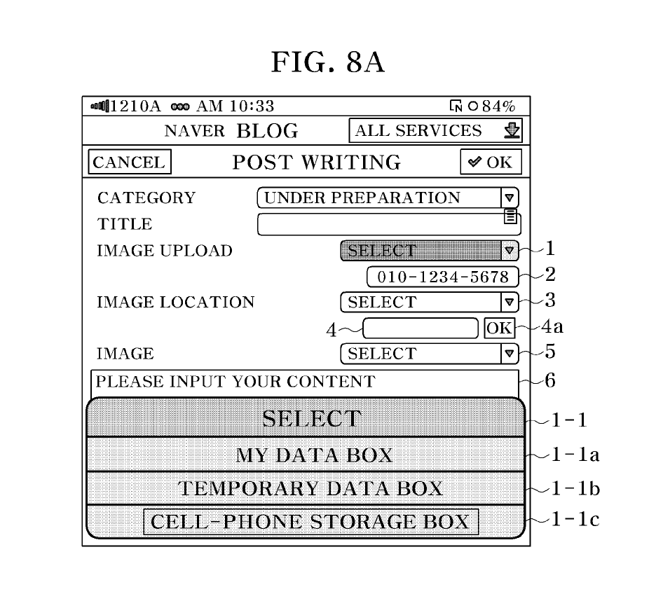

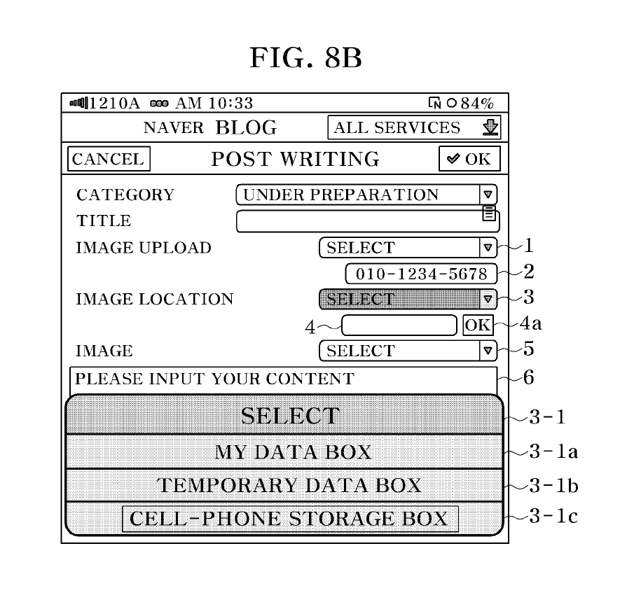

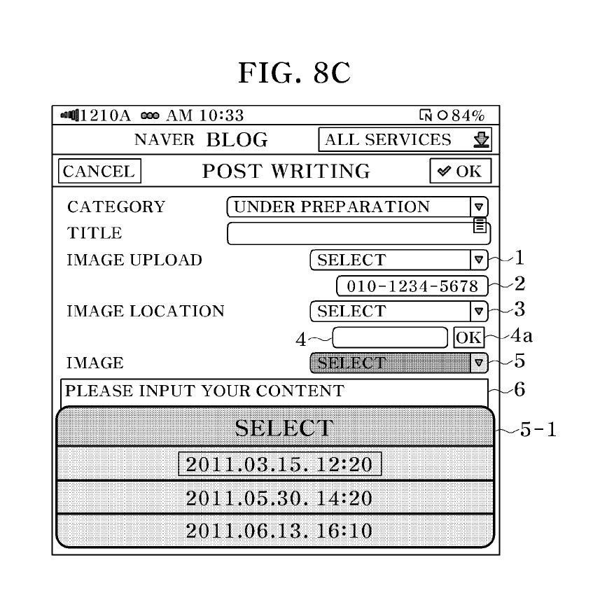

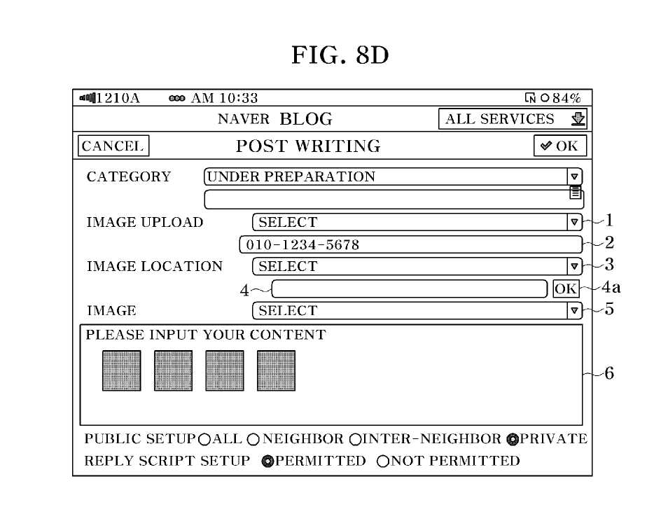

FIG. 7 is a flowchart illustrating a third example of the file upload method using the communication terminal according to the exemplary embodiment of the present invention. FIGS. 8A to 8D illustrate screen configurations of a webpage displayed in the communication terminal, for illustrating the third example of FIG. 7 in detail. FIGS. 7 and 8A to 8D illustrate a method of uploading a file (e.g., an image) to a specific webpage of the web server 200 through a communication terminal 100-1 to 100n, a user of which subscribes to the web server 200 as a member, in the state in which the web server 200 and the message server 400 are established.

Referring to FIGS. 1, 2, 7 and FIGS. 8A to 8D, a user subscribes to the web server 200 as a member by accessing a member subscription webpage provided from the web server 200 using a web browser of a communication terminal 100-1 to 100-n and then performs a member login using a user ID and password provided when the user subscribes to the web server 200 (S300).

When the user subscribes to the web server 200 through the communication terminal 100-1 to 100-n, the web server 200 preferably provides a web service so as to receive information necessary for uploading a file (e.g., an image), e.g., a transmission-side mail account (e.g., abc@tni.com), transmission-side phone number (e.g., 010-XXXX-XXXX), etc.

Next, if the user accesses a specific webpage provided from the web server 200 through the web browser of the communication terminal 100-1 to 100-n, for example, a webpage such as personal blog or Twitter, to which a file can be uploaded (S310), a menu window (e.g., post writing) for posting on a screen of the communication terminal 100-1 to 100-n is displayed, as shown in (b) of FIG. 2 and FIGS. 8A to 8D.

If the user intends to upload any one of files previously stored in the communication terminal 100-1 to 100-n to a specific webpage provided from the web server 200, the user first clicks the key select menu bar 1 provided in the post menu window through the communication terminal 100-1 to 100-n. Then, the corresponding communication terminal 100-1 to 100-n transmits a request message for selecting a specific key value (e.g., a reception-side mail account or phone number) for uploading the file to the web server 200.

Thereafter, when the web server 200 receives the request message for selecting the specific key value for uploading the file from the communication terminal 100-1 to 100-n, as shown in FIG. 8A, the web server 200 provides a web service to the corresponding communication terminal 100-1 to 100-n so that a key select menu window 1-1 for selecting the specific key value is displayed in the form of a popup window.

In this case, the key select menu window 1-1 displayed in the communication terminal 100-1 to 100-n includes a first key select menu button 1-1a for receiving a reception-side mail account for a member, allocated by the web server 200 (e.g., my data box), a second key select menu button 1-1b for receiving a virtual reception-side mail account for a non-member, allocated by the web server 200 (e.g., temporary data box), and a third key select menu button 1-1c for receiving a reception-side phone number for a member/non-member, allocated by the web server 200 (e.g., cell-pone storage box).

If the user clicks the third select menu button 1-1c provided in the key select menu window 1-1 through the communication terminal 100-1 to 100-n, the corresponding communication terminal 100-1 to 100-n transmits a specific key value for uploading the file to the web server 200, i.e., a request message of the reception-side phone number (S320).

Thereafter, when the web server 200 receives the request message of the reception-side phone number from the corresponding communication terminal 100-1 to 100-n, the web server 200 allocates a reception-side phone number (e.g., 010-1234-5678) receivable in the message server 400 regardless of whether a member is logged in, transmits the allocated reception-side phone number to the corresponding communication terminal 100-1 to 100-n, and provides a web service to the corresponding communication terminal 100-1 to 100-n so that the reception-side phone number is displayed in a key display window 2.

Next, the user operates an message application basically built in the communication terminal 100-1 to 100-n, attaches a file to be uploaded together with an MMS message using a previously set transmission-side phone number and the reception-side phone number displayed in the key display window 2, and transmits the MMS message and the attached file to the message server 400 (S330).

Thereafter, the message server 400 receives the MMS message and attached file transmitted to the reception-side phone number from the communication terminal 100-1 to 100-n using the previously set transmission-side phone number and stores and manages the MMS message and the attached file as a database (DB) (S340).

Then, if the user clicks a file location selection menu bar 3 provided in the post menu window through the communication terminal 100-1 to 100-n, the corresponding communication terminal 100-1 to 100-n transmits a request message for selecting the location of the file to be uploaded to the web server 200.

Thereafter, when the web server 200 receives the request message for selecting the location of the file to be uploaded from the communication terminal 100-1 to 100-n, the web server 200 provides a web service to the corresponding communication terminal 100-1 to 100-n so that a file location select menu window 3-1 for selecting the file to be uploaded is displayed in the form of a popup window.

In this case, the file location select menu window 3-1 displayed in the communication terminal 100-1 to 100-n includes, as shown in FIG. 8B, a first file location select menu button 3-1a for selecting an attached file received at the reception-side mail account for a member (e.g., my data box), a second file location select menu button 3-1b for selecting an attached file received at the virtual reception-side mail account for a non-member (e.g., temporary data box), and a third file location select menu button 3-1c for selecting an attached file received at the reception-side phone number for a member/non-member (e.g., cell-phone storage box).

If the user clicks the third file location select menu button 3-1c provided in the file location select menu window 3-1 in the state in which the user is logged into the web server 200 as a member, the corresponding communication terminal 100-1 to 100-n transmits a request message for selecting a file to be uploaded to the web server 200 (S350).

Next, when the web server 200 receives the request message for selecting the file to be uploaded from the communication terminal 100-1 to 100-n, the web server 200 receives message reception information on MMS messages previously stored in the message server 400 and attached files and provides a web service through which the message reception information and the attached files are displayed in the corresponding communication terminal 100-1 to 100-n (S360).

That is, when the web server 200 receives the request message for selecting the file to be uploaded from a communication terminal 100-1 to 100-n, a user of which does not subscribe to the web server 200 as a member, the web server 200 searches for MMS messages transmitted to the transmission-side phone number of the corresponding communication terminal 100-1 to 100-n in connection with the message server 400.

Then, if the user clicks a file select menu bar 5 provided in the post menu window through the communication terminal 100-1 to 100-n, the corresponding communication terminal 100-1 to 100-n transmits, to the web server 200, a request message for displaying information on a file to be selected.

Thereafter, when the web server 200 receives the request message for displaying the information on the file to be selected from the communication terminal 100-1 to 100-n, the web server 200 sorts, for each date, message reception information containing the reception date (year/month/day) and time (hour/minute) of each of the searched MMS messages, and provides a web service through which a file selection menu window 5-1 for selecting an attached file corresponding to the message reception information is displayed in the form of a popup window in the corresponding communication terminal 100-1 to 100-n.

Next, if the user clicks any of the message reception information displayed in the file select menu window 5-1 through the communication terminal 100-1 to 100-n, the web server 200 provides a web service through which the attached file corresponding to the selected message reception information is displayed in an input/display window 6 provided in the post menu window.

Thereafter, the user inputs characters in the input/display window 6 through the communication terminal 100-1 to 100-n and uploads the input characters together with the file displayed in the input/display window 6 to the specific webpage provided to the web server 200 (S370).

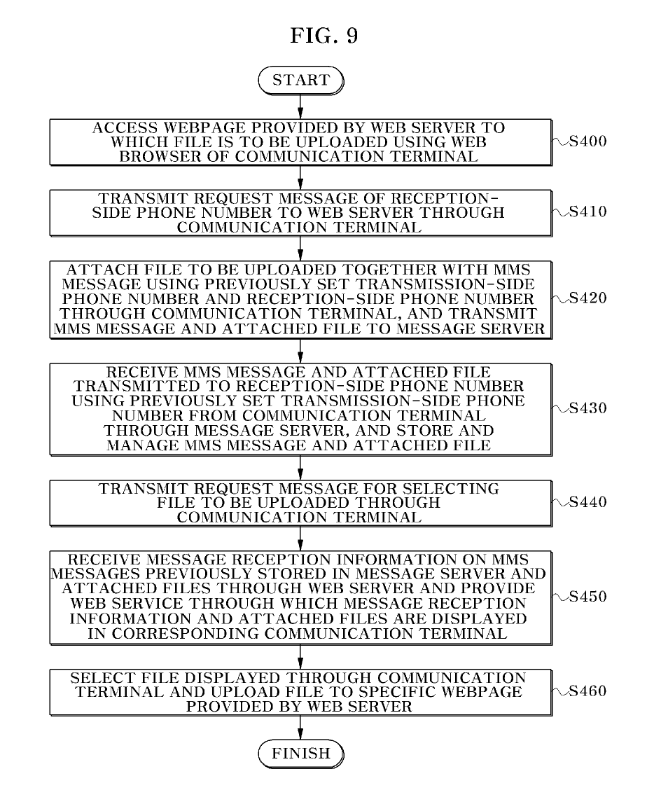

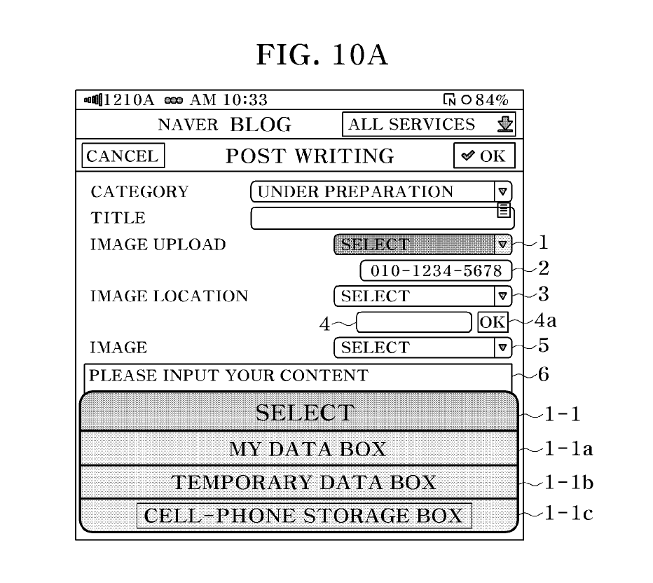

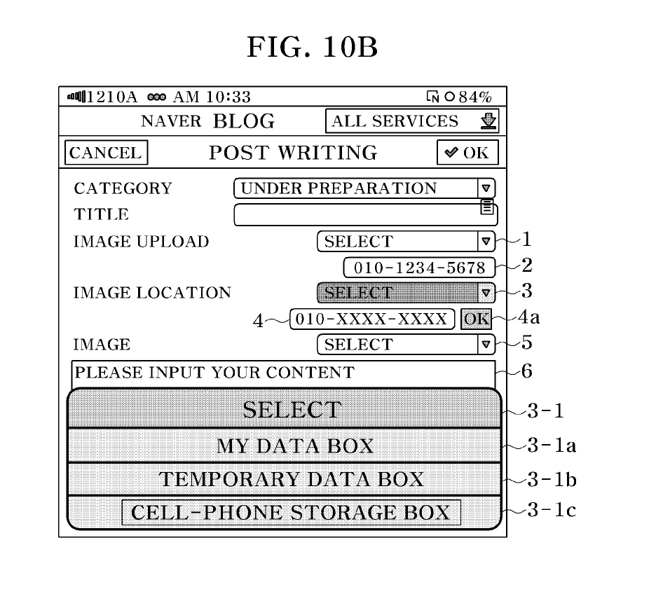

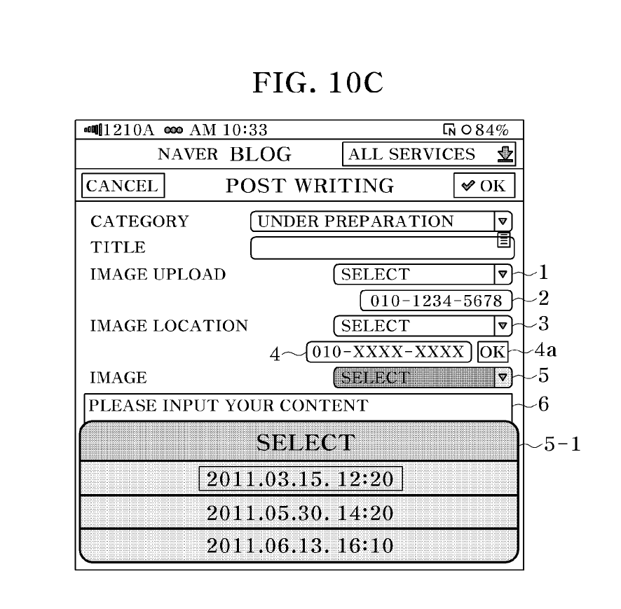

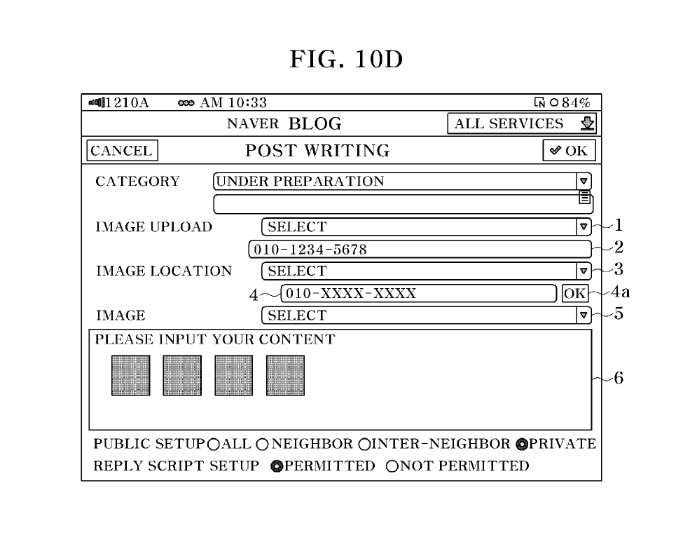

FIG. 9 is a flowchart illustrating a fourth example of the file upload method using the communication terminal according to the exemplary embodiment of the present invention. FIGS. 10A to 10D illustrate screen configurations of a webpage displayed in the communication terminal, for illustrating the fourth example of FIG. 9 in detail. FIGS. 9 and 10A to 10D illustrate a method of uploading a file (e.g., an image) to a specific webpage of the web server 200 through a communication terminal 100-1 to 100n, a user of which does not subscribe to the web server 200 as a member, in the state in which the web server 200 and the message server 400 are built up.

Referring to FIGS. 1, 2, 9 and 10A to 10D, if a user accesses a specific webpage provided from the web server 200, e.g., a webpage such as personal blog or Twitter, to which a file can be uploaded, through a web browser of a communication terminal 100-1 to 100-n (S400), a post menu window for posting (e.g., post writing) is displayed on a screen of the communication terminal 100-1 to 100-n, as shown in (b) of FIG. 2 and FIGS. 10A to 10D.

When the user intends to upload any one of files previously stored in the communication terminal 100-1 to 100-n to a specific webpage provided from the web server 200, the user first clicks the key select menu bar 1 provided in the post menu window through the communication terminal 100-1 to 100-n. Then, the corresponding communication terminal 100-1 to 100-n transmits a request message for selecting a specific key value (e.g., a reception-side mail account, phone number, etc.) for uploading the file to the web server 200.

Thereafter, when the web server 200 receives the request message for selecting the specific key value for uploading the file from the communication terminal 100-1 to 100-n, as shown in FIG. 10A, the web server 200 provides a web service to the communication terminal 100-1 to 100-n so that a key select menu window 1-1 for selecting the specific key value is displayed in the form of a popup window.

In this case, the key select menu window 1-1 displayed in the communication terminal 100-1 to 100-n includes a first key select menu button 1-1a for receiving a reception-side mail account for a member, allocated by the web server 200 (e.g., my data box), a second key select menu button 1-1b for receiving a virtual reception-side mail account for a non-member, allocated by the web server 200 (e.g., temporary data box), and a third key select menu button 1-1c for receiving a reception-side phone number for a member/non-member, allocated by the web server 200 (e.g., cell-pone storage box).

If the user clicks the third select menu button 1-1c provided in the key select menu window 1-1 through the communication terminal 100-1 to 100-n, the corresponding communication terminal 100-1 to 100-n transmits a specific key value for uploading the file to the web server 200, i.e., a request message of the reception-side phone number (S410).

Thereafter, when the web server 200 receives the request message of the reception-side phone number from the corresponding communication terminal 100-1 to 100-n, the web server 200 allocates a reception-side phone number (e.g., 010-1234-5678), transmits the allocated reception-side phone number to the corresponding communication terminal 100-1 to 100-n, and provides a web service to the corresponding communication terminal 100-1 to 100-n so that the virtual reception side mail account is displayed in a key display window 2.

Next, the user operates an message application basically built in the communication terminal 100-1 to 100-n, attaches a file to be uploaded together with an MMS message using a previously set transmission-side phone number and the reception-side phone number displayed in the key display window 2, and transmits the MMS message and the attached file to the message server 400 (S420).

Thereafter, the message server 400 receives the MMS message and attached file transmitted to the previously allocated reception-side phone number from the communication terminal 100-1 to 100-n using the previously set transmission-side phone number (e.g., 010-XXXX-XXXX), and stores and manages the MMS message and the attached file as a database (DB) (S430).

Then, if the user clicks a file location selection menu bar 3 provided in the post menu window through the communication terminal 100-1 to 100-n, the corresponding communication terminal 100-1 to 100-n transmits a request message for selecting the location of the file to be uploaded to the web server 200.

Thereafter, when the web server 200 receives the request message for selecting the location of the file to be uploaded from the communication terminal 100-1 to 100-n, the web server 200 provides a web service to the corresponding communication terminal 100-1 to 100-n so that a file location select menu window 3-1 for selecting the file to be uploaded is displayed in the form of a popup window.

In this case, the file location select menu window 3-1 displayed in the communication terminal 100-1 to 100-n includes, as shown in FIG. 10B, a first file location select menu button 3-1a for selecting an attached file received at the reception-side mail account for a member (e.g., my data box), a second file location select menu button 3-1b for selecting an attached file received at the virtual reception-side mail account for a non-member (e.g., temporary data box), and a third file location select menu button 3-1c for selecting an attached file received at the reception-side phone number for a member/non-member (e.g., cell-phone storage box).

If the user clicks the third file location select menu button 3-1c provided in the file location select menu window 3-1, inputs a previously set transmission-side phone number (e.g., 010-XXXX-XXXX) in an input window 4 provided in the post menu window and then clicks an OK button 4a, in the state in which the user is not logged into the web server 200 as a non-member, the corresponding communication terminal 100-1 to 100-n transmits a request message for selecting a file to be uploaded to the web server 200 (S440).

Next, when the web server 200 receives the request message for selecting the file to be uploaded from the communication terminal 100-1 to 100-n, the web server 200 receives message reception information on MMS messages previously stored in the message server 300 and attached files, and provides a web service through which the message reception information and the attached files are displayed in the corresponding communication terminal 100-1 to 100-n (S450).

That is, when the web server 200 receives the request message for selecting the file to be uploaded from a communication terminal 100-1 to 100-n, a user of which does not subscribe to the web server 200 as a member, the web server 200 searches for MMS messages received at the previously allocated reception-side phone number through a transmission-side mail account of the corresponding communication terminal 100-1 to 100-n in connection with the message server 400.

Then, if the user clicks a file select menu bar 5 provided in the post menu window through the communication terminal 100-1 to 100-n, the corresponding communication terminal 100-1 to 100-n transmits, to the web server 200, a request message for displaying information on a file to be selected.

Thereafter, when the web server 200 receives the request message for displaying the information on the file to be selected from the communication terminal 100-1 to 100-n, as shown in FIG. 10C, the web server 200 sorts, for each date, message reception information containing the reception date (year/month/day) and time (hour/minute) of each of the searched MMS messages, and provides a web service through which a file selection menu window 5-1 for selecting an attached file corresponding to the message reception information is displayed in the form of a popup window in the corresponding communication terminal 100-1 to 100-n.

Next, if the user clicks any of the message reception information displayed in the file select menu window 5-1 through the communication terminal 100-1 to 100-n, as shown in FIG. 10D, the web server 200 provides a web service through which the attached file corresponding to the selected message reception information is displayed in an input/display window 6 provided in the post menu window.

Thereafter, the user inputs characters in the input/display window 6 through the communication terminal 100-1 to 100-n and uploads the input characters together with the file displayed in the input/display window 6 to the specific webpage provided to the web server 200 (S460).

As described above, in the file upload system using a communication terminal and the method thereof according to the present invention, a file is uploaded to a web server using a file attached to an e-mail or MMS message transmitted to a separate mail server or message server linked with the web server, instead of a conventional method of uploading a file (e.g., an image, photograph, moving picture, document file, etc.) to a web server running a webpage such as a blog or Twitter through a communication terminal using a separate application, thereby effectively reducing a huge cost necessary for developing and producing a conventional application for file uploading.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A file upload system using a communication terminal, comprising:
a communication terminal having a web browser built therein and performing electronic mail (e-mail) transmission;
a mail server receiving an attached file together with an e-mail transmitted to at least one previously allocated reception-side mail account from the communication terminal, using a previously set transmission-side mail account, and storing the received e-mail and attached file; and
a web server providing a webpage to which a file is to be uploaded to the communication terminal, allocating a reception-side mail account receivable in the mail server and transmitting the allocated reception-side mail account to the communication terminal, receiving the attached file of the e-mail previously stored in the mail server in connection with the mail server and providing a web service through which the received attached file is displayed through the web browser of the communication terminal, and providing a web service through which the file is uploaded to the corresponding webpage.

2. The file upload system of claim 1, wherein the mail server establishes, as a database for each transmission-side mail account, the attached file together with the e-mail received at the reception-side mail account previously allocated to the communication terminal through the web server, and stores the e-mail and the attached file.

3. The file upload system of claim 1, wherein the web server allocates a reception-side mail account for a member using a member login ID of a communication terminal, a user of which subscribes to the web server as a member, and transmits the allocated reception-side mail account to the corresponding communication terminal, and the web server arbitrarily allocates a virtual reception-side mail account to a user of a communication terminal, a user of which does not subscribe to the web server as a member, and transmits the allocated virtual reception-side mail account to the corresponding communication terminal.

4. The file upload system of claim 3, wherein, when the web server receives a request message for selecting a file to be uploaded from the communication terminal, the user of which subscribes to the web server as a member, the web server searches for e-mails transmitted to a transmission-side mail account of the communication terminal, the user of which subscribes to the web server as a member, or received at the reception-side mail account for a member in connection to the mail server, provides a web service through which mail reception information containing the reception date and time of each of the searched e-mails is sequentially displayed in the corresponding communication terminal, and provides a web service through which an attached file corresponding to the displayed mail reception information is selectively displayed in the corresponding communication terminal.

5. The file upload system of claim 3, wherein, when the web server receives a request message for selecting a file to be uploaded from the communication terminal, the user of which does not subscribe to the web server as a member, the web server searches for e-mails received at the virtual reception-side mail account through the corresponding communication terminal in connection to the mail server, provides a web service through which mail reception information containing the reception date and time of each of the searched e-mails is sequentially displayed in the corresponding communication terminal, and provides a web service through which an attached file corresponding to the displayed mail reception information is selectively displayed in the corresponding communication terminal.

6. The file upload system of claim 3, wherein the web server deletes, after a predetermined time, the e-mail stored in the mail server and the attached file corresponding to the e-mail together with the allocated virtual reception-side mail account.

7. A file upload system using a communication terminal, comprising:
a communication terminal having a web browser built therein and performing multimedia messaging service (MMS) message transmission;
a message server receiving an attached file together with an MMS message transmitted to at least one previously allocated reception-side phone number, using a transmission-side phone number of the communication terminal, and storing the received MMS message and attached file; and
a web server providing a webpage to which a file is to be uploaded to the communication terminal, allocating a reception-side phone number receivable in the message server and transmitting the allocated reception-side phone number to the communication terminal, receiving the attached file of the MMS message previously stored in the message server in connection with the message server and providing a web service through which the received attached file is displayed through the web browser of the communication terminal, and providing a web service through which the file is uploaded to the corresponding webpage.

8. The file upload system of claim 7, wherein the message server establishes, as a database for each transmission-side phone number, the attached file together with the MMS message received at the reception-side phone number previously allocated to the communication terminal through the web server, and stores the MMS message and the attached file.

9. The file upload system of claim 7, wherein, when the web server receives a request message for selecting a file to be uploaded from the communication terminal, the web server searches for MMS messages received at the transmission-side phone number of the corresponding communication terminal among the MMS messages received at the reception-side phone number allocated to the communication terminal in connection to the message server, provides a web service through which message reception information containing the reception date and time of each of the searched MMS messages is sequentially displayed in the corresponding communication terminal, and provides a web service through which an attached file corresponding to the displayed message reception information is selectively displayed in the corresponding communication terminal.

10. A method of uploading a file to a webpage provided from a web server using a system which comprises a communication terminal having a web browser built therein and performing e-mail transmission, a web server and a mail server, the method comprising:
(a) accessing a webpage to which a file provided from the web server is to be uploaded through the web browser of the communication terminal;
(b) allocating, by the web server, a reception-side mail account receivable in the mail server and transmitting the allocated reception-side mail account to the communication terminal, when receiving a request message of a mail account for file uploading from the communication terminal through the web server;
(c) transmitting an attached file together with an e-mail to the mail server using a transmission-side mail account previously set through the communication terminal and the allocated reception-side mail account;
(d) receiving e-mails and attached files transmitted to at least one previously allocated reception-side mail account using the transmission-side mail account previously set from the communication terminal through the mail server, and storing the received e-mails and attached files;
(e) receiving, by the web server, mail reception information on e-mails previously stored in the mail server and attached files, and providing a web service through which the received mail reception information and attached files are displayed in the communication terminal, when receiving a request message for selecting a file to be uploaded from the communication terminal through the web server; and
(f) selecting at least one of the attached files displayed in step (e) through the communication terminal, and uploading the selected attached file to the webpage provided from the web server.

11. The method of claim 10, wherein, in step (b), when the web server receives the request message of the mail account for file uploading from the communication terminal, the web server determines the presence of a member login of the corresponding communication terminal, allocates a reception-side mail account for a member using a member login ID of a communication terminal, a user of which subscribes to the web server as a member, and transmits the allocated reception-side mail account to the corresponding communication terminal, and the web server arbitrarily allocates a virtual reception-side mail account to a user of a communication terminal, a user of which does not subscribe to the web server as a member, and transmits the allocated virtual reception-side mail account to the corresponding terminal.

12. The method of claim 11, wherein the web server deletes, after a predetermined time, the e-mail stored in the mail server and the attached file corresponding to the e-mail together with the allocated virtual reception-side mail account.

13. The method of claim 10, wherein, in step (d), the mail server establishes, as a database for each transmission-side mail account, the attached file together with the e-mail received at the reception-side mail account previously allocated to the communication terminal through the web server, and stores the e-mail and the attached file.

14. The method of claim 10, wherein, in step (e), when the web server receives a request message for selecting a file to be uploaded from the communication terminal, the user of which subscribes to the web server as a member,
the web server searches for e-mails transmitted to a transmission-side mail account of the communication terminal, the user of which subscribes to the web server as a member, or received at the reception-side mail account for a member in connection to the mail server, provides a web service through which mail reception information containing the reception date and time of each of the searched e-mails is sequentially displayed in the corresponding communication terminal, and provides a web service through which an attached file corresponding to the displayed mail reception information is selectively displayed in the corresponding communication terminal.

15. The method of claim 10, wherein, in step (e), when the web server receives a request message for selecting a file to be uploaded from the communication terminal, the user of which does not subscribe to the web server as a member, the web server searches for e-mails received at the virtual reception-side mail account through the corresponding communication terminal in connection to the mail server, provides a web service through which mail reception information containing the reception date and time of each of the searched e-mails is sequentially displayed in the corresponding communication terminal, and provides a web service through which an attached file corresponding to the displayed mail reception information is selectively displayed in the corresponding communication terminal.

16. A method of uploading a file to a webpage provided from a web server using a system which comprises a communication terminal having a web browser built therein and performing MMS message transmission, a web server and a message server, the method comprising:
(a′) accessing a webpage to which a file provided from the web server is to be uploaded through the web browser of the communication terminal;
(b′) allocating, by the web server, a reception-side phone number receivable in the message server and transmitting the allocated reception-side phone number to the communication terminal, when receiving a request message of a phone number for file uploading from the communication terminal through the web server;
(c′) transmitting an attached file together with an MMS message to the message server using a transmission-side phone number previously set through the communication terminal and the allocated reception-side phone number;
(d′) receiving MMS messages and attached files transmitted to at least one previously allocated reception-side phone number using the transmission-side phone number previously set from the communication terminal through the message server, and storing the received MMS messages and attached files;
(e′) receiving, by the web server, message reception information on MMS messages previously stored in the message server and attached files, and providing a web service through which the received message reception information and attached files are displayed in the communication terminal, when receiving a request message for selecting a file to be uploaded from the communication terminal through the web server; and
(f′) selecting at least one of the attached files displayed in step (e′) through the communication terminal, and uploading the selected attached file to the webpage provided from the web server.

17. The method of claim 16, wherein, in step (d′), the message server establishes, as a database for each transmission-side phone number, the attached file together with the MMS message received at the reception-side phone number previously allocated to the communication terminal through the web server, and stores the MMS message and the attached file.

18. The method of claim 16, wherein, in step (e′), when the web server receives a request message for selecting a file to be uploaded from the communication terminal, the web server searches for MMS messages received at the transmission-side phone number of the corresponding communication terminal among the MMS messages received at the reception-side phone number allocated to the communication terminal in connection to the message server, provides a web service through which message reception information containing the reception date and time of each of the searched MMS messages is sequentially displayed in the corresponding communication terminal, and provides a web service through which an attached file corresponding to the displayed message reception information is selectively displayed in the corresponding communication terminal.
